(19) United States
(12) Patent Application Publication
(10) Pub. No.: US 2011/0004644 A1
(43) Pub. Date: Jan. 6, 2011

(54) DYNAMIC FLOATING POINT REGISTER PRECISION CONTROL

(75) Inventors: G. Glenn Henry, Austin, TX (US); Rodney E. Hooker, Austin, TX (US); Terry Parks, Austin, TX (US)

Correspondence Address: HUFFMAN LAW GROUP, P.C., 1900 MESA AVE., COLORADO SPRINGS, CO, 80906, US

(73) Assignee: VIA Technologies, Inc., Taipei (TW)

(21) Appl. No.: 12/497,570

(22) Filed: Jul. 3, 2009

(51) Int. Cl. G06F 9/302; G06F 7/38

(52) U.S. Cl. 708/231; 712/222; 712/E09.017; 708/495

(57) ABSTRACT

Apparatus and methods are provided to perform floating point operations that are adaptive to the precision formats of input operands. The apparatus includes adaptive conversion logic and a tagged register file. The adaptive conversion logic receives the input operands, where each of the input operands is of a corresponding precision. The adaptive conversion logic also records the corresponding precision for use in subsequent floating point operations. The tagged register file is coupled to the adaptive conversion logic. The tagged register file stores the each of the input operands, and stores the corresponding precision and furthermore associates the corresponding precision with the each of the input operands. The subsequent floating point operations are performed at a precision level according to the corresponding precision.

### BACKGROUND OF THE INVENTION

1. Field of the Invention

This invention relates in general to the field of microelectronics, and more particularly to apparatus and methods in a microprocessor or similar device for performing floating point operations which are adaptive to the precision of input operands.

2. Description of the Related Art

Early microprocessors performed operations on values fetched from memory and stored in internal registers. And the types of data that could be stored in these internal registers, as known by the microprocessors, was sparse at best. Signed integer arithmetic was provided for by associated instructions. In order to perform operations that involved operands representing real numbers, a programmer was forced to design elaborate encoding schemes for the numbers themselves and complex algorithms to perform meaningful operations on the encoded numbers. It was extremely difficult to multiply two non-integer numbers together to yield a result.

In 1985, IEEE Standard 754 was instituted thereby standardizing how real, or floating point, numbers were to be represented in binary form for processing by a digital computer. The Standard specified three formats: single precision format, double precision format, and double extended precision format. Each of the precision formats provide for a range of numbers which can be represented.

Not long thereafter, microprocessor manufacturers began producing so-called floating point coprocessors, the most notable of which was the 8087 coprocessor, produced by Intel Corporation. These coprocessors worked in conjunction with a main processor to perform floating point operations on floating point operands provided in one or more of the IEEE Standard 754 formats. Typically, floating point operands were fetched from memory and handed off to the floating point coprocessor. The floating point coprocessor stored these operands in a register file therein and all floating point instructions for the coprocessor operated on contents of the register file and returned results to the register file.

Although the above noted floating point coprocessing logic has been long ago incorporated into the same integrated circuit that includes remaining elements of a microprocessor, the legacy remains in terms of how floating point operands are fetched from memory, how they are stored in a floating point register file, and how they are subsequently operated upon to generate a result. More specifically, x86-compatible microprocessor architectures contain provisions for a programmer to store a floating point operand in a variety of precisions in memory, once the floating point operand is fetched from memory for storage in a floating point register file, it is up-converted to the highest precision level provided for by the microprocessor and is stored and operated upon at this highest precision level. For example, although a floating point operand for an x86-compatible microprocessor may be provided in memory as single precision, double precision, or double extended precision, when it is loaded from memory, it is converted to a double extended precision operand and is subsequently operated upon using double extended precision algorithms and techniques as prescribed by subsequent floating point instructions.

The above noted conversion and loss of originally specified precision of a floating point operand is problematic in a present day microprocessor for, as one skilled in the art will appreciate, it takes longer to perform some floating point operations, such as multiply, divide, and square root, on one or more double extended precision operands than it would otherwise take to perform the same operation on, say, two single precision operands.

The present inventors have observed these problems and limitations of the art and have furthermore noted a need to preserve a floating point operand's original precision and to employ this preserved precision when performing subsequent floating point operations on the floating point operand so that execution time can be decreased.

### SUMMARY OF THE INVENTION

The present invention, among other applications, is directed to solving the above-noted problems and addresses other problems, disadvantages, and limitations of the prior art. In one embodiment, a microprocessor apparatus is provided. The microprocessor apparatus is configured to perform floating point operations that are adaptive to the precision formats of input operands. The microprocessor apparatus includes adaptive conversion logic and a tagged register file. The adaptive conversion logic receives the input operands, where each of the input operands is of a corresponding precision. The adaptive conversion logic also records the corresponding precision for use in subsequent floating point operations. The tagged register file is coupled to the adaptive conversion logic. The tagged register file stores the each of the input operands, and stores the corresponding precision and furthermore associates the corresponding precision with the each of the input operands. The subsequent floating point operations are performed at a precision level according to the corresponding precision as specified by a floating point control word.

One aspect of the present invention contemplates an apparatus in a microprocessor for performing floating point operations that are adaptive to the precisions of input operands. The apparatus has adaptive conversion logic and a plurality of tagged registers. The adaptive conversion logic is configured to receive the input operands, where each of the input operands is of a corresponding precision. The adaptive conversion logic is also configured to preserve the corresponding precision for use in subsequent floating point operations. The plurality of tagged registers is coupled to the adaptive conversion logic. Each of the plurality of tagged registers is configured to store the each of the input operands. Each of the plurality of tagged registers includes a precision tag field and a significand field. The precision tag field stores a value indicating the corresponding precision. The significand field is coupled to the precision tag field, and is configured to store a significand corresponding to the each of the input operands. The subsequent floating point operations are performed at a precision level according to the corresponding precision as specified by a floating point control word

Another aspect of the present invention comprehends a method for performing floating point operations in a microprocessor that are adaptive to the precision formats of input operands. The method includes receiving the input operands, where each of the input operands is of a corresponding precision; preserving the corresponding precision when the each of the input operands is converted to a storage precision, and storing the corresponding precision in a tagged register; and providing the corresponding precision for use in a subsequent floating point operation.

Regarding industrial applicability, the present invention is implemented within a MICROPROCESSOR which may be used in a general purpose or special purpose computing device.

### BRIEF DESCRIPTION OF THE DRAWINGS

These and other objects, features, and advantages of the present invention will become better understood with regard to the following description, and accompanying drawings where:

FIG. 1 is a prior art block diagram illustrating how floating point numbers are encoded for performing floating point operations in accordance with IEEE Standard 754-1985, IEEE Standard for Binary Floating-Point Arithmetic;

FIG. 2 is a prior art block diagram depicting a floating point register stack for storage of floating point operands within a present day microprocessor;

FIG. 3 is a prior art block diagram illustrating how a present day microprocessor performs floating point operations on input operands which are fetched from memory and stored in a floating point register stack;

FIG. 4 is a block diagram showing a microprocessor apparatus according to the present invention for providing dynamic control of floating point operands fetched from memory and operated upon;

FIG. 5 is a block diagram illustrating a precision tagged floating point register file according to the present invention;

FIG. 6 is a block diagram detailing an adaptive floating point result register according to the present invention;

FIG. 7 is a table showing exemplary encodings of the precision tags of the tagged floating point register file of FIG. 5 and the adaptive result register of FIG. 6;

FIG. 8 is a block diagram featuring a exemplary embodiment of adaptive floating point execution logic according to the present invention;

FIG. 9 is a block diagram showing an alternative embodiment of adaptive floating point execution logic according to the present invention; and

FIG. 10 is a flowchart illustrating a method according to the present invention for performing precision-adaptive floating point operations.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

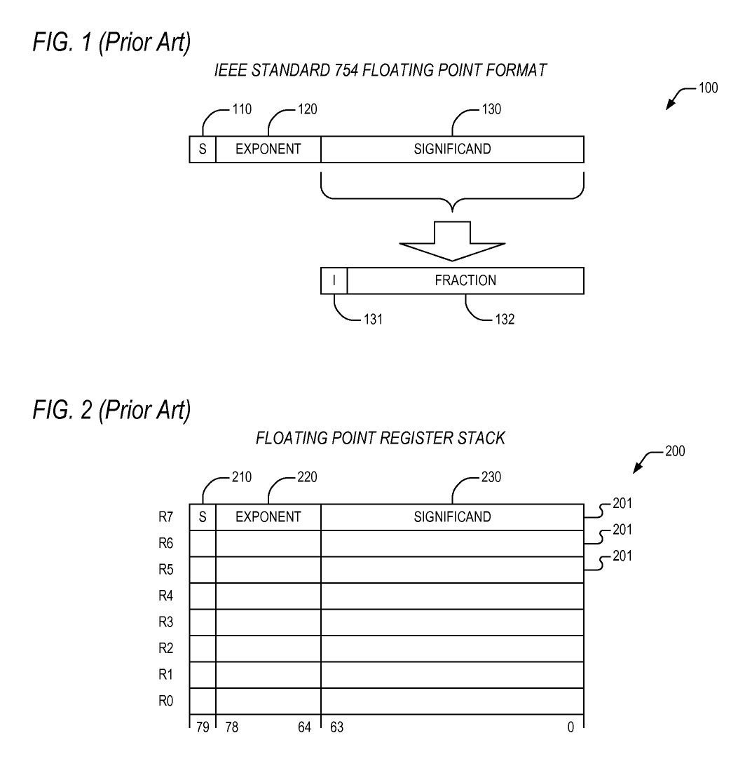

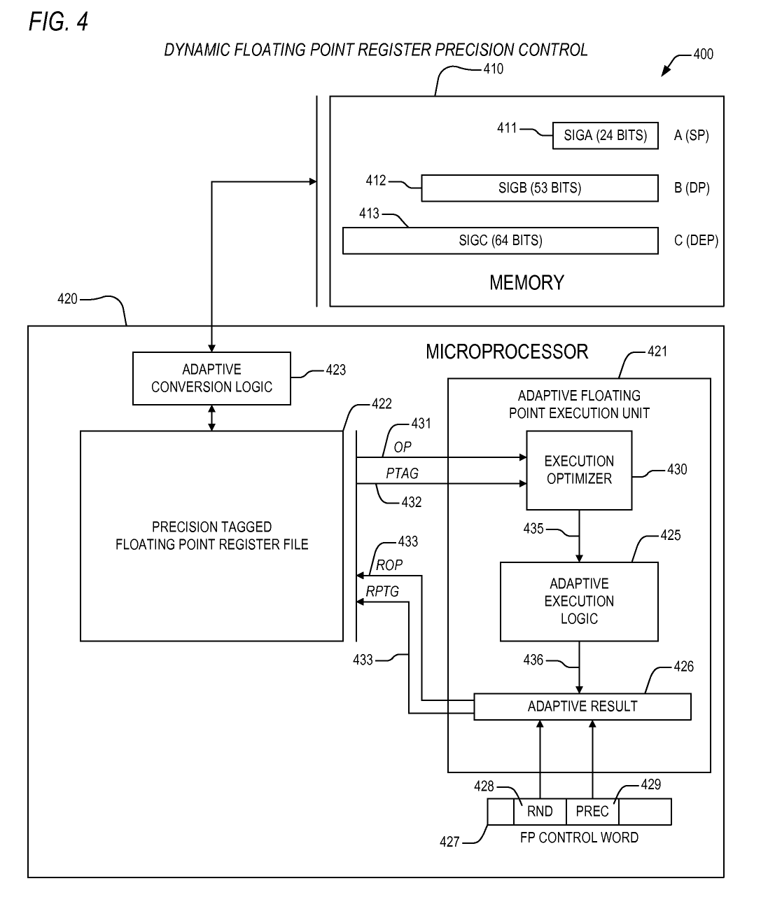

In view of the above background discussion on the encoding and storage of floating point operands and associated techniques employed within present day microprocessors for the performance of floating point operations using these operands, a discussion will now be provided with reference to FIGS. 1-3 that highlights the limitations and disadvantages of conventional floating point techniques. Following this, a discussion of the present invention will be presented with reference to FIGS. 4-10. It will be shown how the present invention overcomes the problems and limitations of present day floating point techniques and moreover will highlight advantages and features of the present invention that provide for, among other things, faster and more efficient execution of floating point operations.

Turning to FIG. 1, block diagram 100 is presented illustrating how floating point numbers are encoded for performing floating point operations in accordance with IEEE Standard 754-1985, IEEE Standard for Binary Floating-Point Arithmetic. The IEEE Standard, which is herein incorporated by reference for all intents and purposes, provides for encoding of floating point numbers according to three precision formats: single precision format, double precision format, and double extended precision format. All three of the formats provide for encoding fields 110, 120, 130 as shown in the block diagram 100. A 1-bit sign field 110 encodes whether a floating point number is positive or negative. An exponent field 120 encodes a biased exponent for the floating point number. And a significand field 130 is employed to encode a significand for the floating point number. The significand comprises both an integer part and a fraction part. The differences in the three formats involve the employment of an increasingly greater number of bits in both the exponent field 120 and the significand field 130 to represent increasingly wider ranges of floating point numbers. For a floating point number represented in double extended precision format, the exponent field 120 is 15 bits and the significand field 130 is 64 bits. For the double extended precision format, the significand field 130 has both an integer (or “J”) bit field 131 and a 63-bit fraction field 132. Double extended precision numbers are stored in memory in 10 consecutive bytes (80-bits). For a floating point number represented in double precision format, the exponent field 120 is 11 bits and the significand field 130 is 52 bits. All 52 bits of the significand field 130 are employed to encode the fraction part of the significand. The integer bit 131 is implied. Double precision numbers are stored in memory in 8 consecutive bytes (64-bits). For a floating point number represented in single precision format, the exponent field 120 is 8 bits and the significand field 130 is 23 bits. All 23 bits of the significand field 130 are employed to encode the fraction part of the significand. The integer bit 131 is implied. Single precision numbers are stored in memory in 4 consecutive bytes (32-bits).

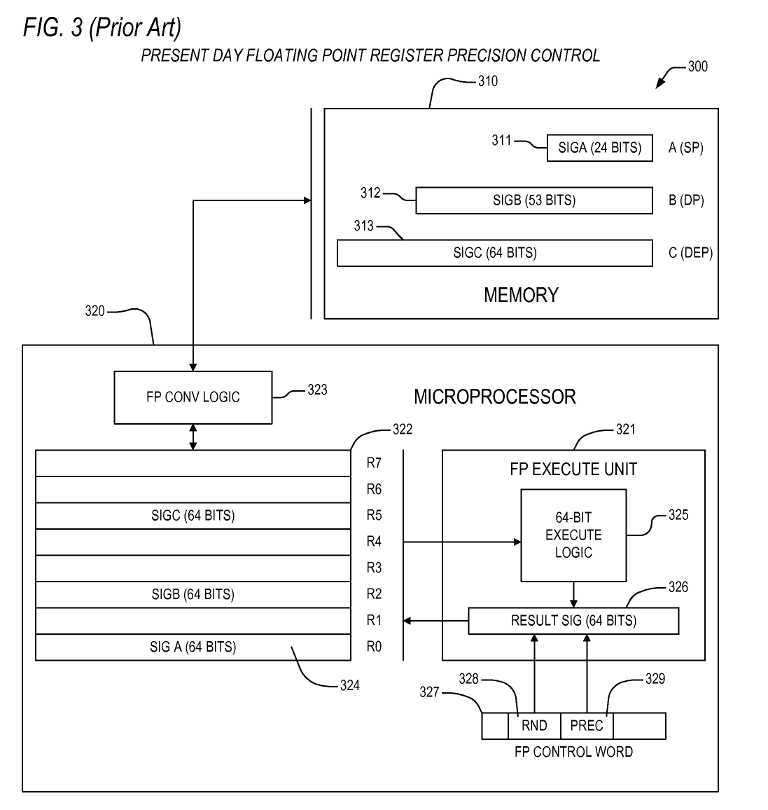

In a conventional application where floating point operands are stored in memory and are fetched by an x86-compatible microprocessor for the performance of floating point operations such as floating point addition, floating point subtraction, floating point multiplication, floating point division, and including, but not limited to transcendental functions (e.g., sine, exponent, logarithm), with the exception of the 80-bit double extended precision floating point format, the other two precision formats exist only in memory. This is because when floating point numbers are fetched from memory and into internal storage in the x86-compatible microprocessor, the floating point numbers are converted into the 80-bit double extended precision format and subsequent floating point operations are performed in the double extended precision format. This technique allows for a floating point operation to be performed on operands of differing precisions without any loss of precision in the result. But the present inventors have noted that this conventional technique for storing floating point numbers within a microprocessor and performing floating point operations thereon is disadvantageous from several perspectives, as will be described in greater detail herein below. At this point, it is sufficient to note that when a floating point number in single precision format or double precision format is fetched from memory and is stored for access within an x86-compatible microprocessor, with the exception of special numerical values the process of converting the floating point number to double extended precision format is accomplished in one respect by simply appending some number of zeros in the least significant bit positions of the significand field 130 and modifying the exponent field 120 due to the additional bits therein. Following conversion of the floating point number to the double extended precision format that is used for storage and operations within the x86-compatible microprocessor, its original precision, that is, the precision with which the programmer provided the operand in memory, is lost. Consequently, any subsequent floating point operation that is to be performed on the converted floating point number must be performed in accordance with double extended precision format, which will necessarily include a significant number of sub-operations, or steps, or iterations of a floating point algorithm, on significand bits of lesser significance that are set to zero. And, as one skilled in the art will appreciate, to execute sub-operations on bits, regardless of their state, takes time. In addition, one skilled in the art will appreciate that the execution of floating point operations by a present day microprocessor, such as an x86-compatible processor, is a notable bottleneck in performance. This problem will now be described in further detail with reference to FIGS. 2 and 3.

Referring to FIG. 2, a prior art block diagram is presented depicting a floating point register stack 200 for storage of floating point operands within a present day microprocessor. The specific configuration of the stack 200 comports with the architecture of an x87 floating point register stack within an x86-compatible microprocessor. This architecture is well known in the art and is employed to teach limitations associated with present day floating point techniques, however, the present inventors note that such an architecture is employed only for purposes of teaching general limitations of the state of the art. The floating point register stack 200 includes eight floating point registers 201, noted in the diagram as registers R0-R7, which can be specified by floating point instructions in a corresponding instruction set architecture. For example, in an x86-compatible microprocessor, a floating point multiply instruction, FMUL ST(i), ST(0), directs the microprocessor to multiply the floating point number stored in the ST(i) register 201 by the contents of the ST(0) register 201, and to store the result of the floating point multiplication in the ST(i) register 201. By convention, an x87 floating point register file 200 is organized as a stack configuration and the operands ST(0) and ST(i) refer to registers 201 relative to the register 201 designated as the top of the stack 200. Each of the registers 201, as noted above, is configured for storage and representation of floating point operands in double extended precision format. Accordingly, each register 201 has a 1-bit sign field 210, a 15-bit exponent field 220, and a 64-bit significand field 230. Consequently, when any floating point operand is fetched from memory and loaded into a register 201, it is converted into double extended precision format. For example, when a single precision operand is fetched from memory and is loaded into, say, register R3 201, an additional 40 bits set to zero are appended to the significand and its exponent is modified to comport with the increased number of exponent bits. In terms of its significand, when the single precision operand is loaded into register R3 201, bits 39:0 of the significand field 230 are set to zero. And any subsequent floating point operation that may be performed on the contents of register R3 201, will require that corresponding sub-operations be executed on these “zero” bits in positions 39:0. This is because a conventional floating point register file 200 is fixed at the highest level precision at which the microprocessor is capable of performing floating point operations. It is noted that although virtually all present day microprocessors comport with the precisions of IEEE Standard 754, the present invention that is described herein below need not be tied to IEEE Standard 754 precisions, and may be practiced under other architectural formats as well as those comporting with the IEEE Standard.

Now turning to FIG. 3, a prior art block diagram 300 is presented illustrating how a present day microprocessor performs floating point operations on input operands which are fetched from memory and stored in a floating point register stack. The block diagram 200 depicts an x86-compatible microprocessor 320 that is operatively coupled to a memory 310 for purposes of loading and storing floating point operands and performing floating point operations thereon. For clarity of discussion, only those elements of the microprocessor 320 and memory 310 that are required to teach limitations of the art are depicted. For example, it is well known in the art that an x86-compatible microprocessor 320 includes logic for retrieving operands from memory, but such logic is not shown because it is sufficient to know that the operands are retrieved. Accordingly, the microprocessor 320 has a floating point register file 322 comprising floating point registers R0-R7. Each of the registers R0-R7 has a significand field 324 that provides for storage of a double extended precision significand. For clarity, sign and exponent fields of the registers R0R7 are not shown. The register file 322 is coupled to floating point conversion logic 323 and also to a conventional floating point execution unit 321 such as, for example, and x86 floating point unit within the x86-compatible microprocessor 320. The floating point execution unit 321 includes 64-bit execution logic 352 that provides a floating point result to a floating point result register 326. For clarity, only the significand portion of the result is shown in the register 326, however, it is noted that the register also includes a sign and exponent corresponding to a floating point result. The floating point execution unit 321 is also coupled to a floating point control word 327. The floating point control word 327 has a rounding control field 328 and a precision control field 329. The value of the precision control field 329 indicates a result precision (e.g., single, double, double extended) to which a floating point result is to be rounded. The contents of the rounding control field indicates how the result is to be rounded to the specified result precision. Example rounding schemes include round to nearest, round down, round up, and round toward zero (i.e., truncate).

Significands 311-313 corresponding to three floating point numbers A-C are shown stored within the memory 310. Number A is stored as a single precision number having a 24-bit significand 311. Number B is stored as a double precision number having a 52-bit significand 312. And number C is encoded as a double extended precision number having a 64-bit significand 313. As the block diagram depicts, when number A is fetched from the memory 310, its 24-bit significand 311 is expanded to a 64-bit significand by the floating point conversion logic 323 for storage in register R0 as a double extended precision number. Accordingly, the lower 40 bits of the significand field 324 of register R0 are set to zero. In substantially similar manner, when number B is fetched from the memory 310, its 52-bit significand 312 is expanded to a 64-bit significand by the floating point conversion logic 323 for storage in register R2 as a double extended precision number. Thus, the lower 11 bits of the significand field 324 of register R2 are set to zero. And since number C is stored in memory 310 in double extended precision format, the 64-bit significand 313 is merely transferred to the 64-bit significand field 324 of register R5. After numbers A-C have been fetched from the memory 310, converted by the conversion logic 323 to double extended precision format, and loaded into the register file 322, they are thereafter operated upon as double extended precision numbers having 64-bit significands. Consequently, to perform a floating point operation on the contents of register R0 (formerly having only 24 bits of significand) requires as many steps and/or sub-operations as it does to perform the same floating point operation on the contents of register R5. Likewise, to multiply the contents of register R0 with itself requires a full 64-bit multiplication by the 64-bit execute logic, which requires the same amount of time as it does to multiply the contents of register R5 with itself. And the present inventors have observed this phenomena is present in virtually all present day x86-compatible microprocessors, to with: it takes the same amount of time (i.e., cycles of a core clock signal (not shown)) to perform a given floating point operation on one or more input operands, regardless of whether all of those input operands are provided from memory 310 as single precision operands, double precision operands, or double extended precision operands. This is unfortunate and is seen as a limiting factor in the execution of many application programs.

For instance, it is not uncommon for application programs written in high level languages such as C to specify floating point calculations, that is, input values and results, with double precision. Accordingly, instructions are executed to set the value of the precision field 329 in the floating point control word 327 to, say, double precision format. But even though double precision is specified by the precision field for results and input operands are provided from memory 310 in double precision format, the floating point operations that are performed on the input operands are double extended precision operations. This is because the conventional floating point unit 321 is only provided with double extended precision operands from the floating point register file 322. Yet, the results of these double extended precision floating point operations are rounded to double precision format and are stored back into the register file with zeros in the least significant bit positions of their corresponding significand field 324.

The present invention overcomes the disadvantages and limitations of the present art noted above, and others, by providing apparatus and methods whereby precision-adaptive floating point operations can be performed on one or more input operands, where the operation precision that is employed to perform the precision-adaptive floating point operations is determined as a function of the highest precision level of the one or more input operands. To accomplish this, apparatus and methods are provided according to the present invention that preserve the corresponding precision level of each of the input operands after they have been fetched from memory. The present invention will now be described with reference to FIGS. 4-10.

Referring to FIG. 4, a block diagram 400 is presented showing a microprocessor apparatus according to the present invention for providing dynamic control of floating point operands fetched from memory and operated upon. The block diagram 300 depicts a microprocessor 420 according to the present invention that is operatively coupled to a memory 410 for purposes of loading and storing floating point operands and performing precision-adaptive floating point operations thereon. For clarity of discussion, only those elements of the microprocessor 420 and memory 410 that are required to teach essential concepts of the present invention are depicted. Like the present day microprocessor 320 described above with reference to FIG. 3, the microprocessor 420 according to the present invention includes logic for retrieving operands from memory, and other elements as well, but such logic is not shown in the block diagram 400 because such additional details would tend to obfuscate the present invention. Accordingly, the microprocessor 420 has a precision tagged floating point register file 422 comprising a plurality of tagged floating point registers (not depicted). The register file 422 according to the present invention is configured to preserve the corresponding precisions of input operands stored therein for use in subsequent floating point operations that are performed. The register file 422 comprises logic, circuits, devices, or microcode (i.e., micro instructions or native instructions), or a combination of logic, circuits, devices, or microcode, or equivalent elements that are employed to store precision tagged floating point operands according to the present invention. The elements employed to store the precision tagged floating point operands within the register file 422 may be shared with other circuits, microcode, etc., that are employed to perform other functions within the microprocessor 420. According to the scope of the present application, microcode is a term employed to refer to a plurality of micro instructions. A micro instruction (also referred to as a native instruction) is an instruction at the level that a unit executes. For example, micro instructions are directly executed by a reduced instruction set computer (RISC) microprocessor. For a complex instruction set computer (CISC) microprocessor such as an x86-compatible microprocessor, x86 instructions are translated into associated micro instructions, and the associated micro instructions are directly executed by a unit or units within the CISC microprocessor. The register file 422 is coupled to adaptive conversion logic 423 and also to an adaptive floating point execution unit 421. Both the adaptive conversion logic 423 and the adaptive floating point execution unit 421 comprise logic, circuits, devices, or microcode (i.e., micro instructions or native instructions), or a combination of logic, circuits, devices, or microcode, or equivalent elements that are employed to perform their corresponding functions according to the present invention as described below. The elements employed to perform their corresponding functions may be shared with other circuits, microcode, etc., that are employed to perform other functions within the microprocessor 420. In one embodiment, the execution unit 421 is configured as an x86-compatible floating point unit (i.e., x87 floating point unit 421) within an x86-compatible microprocessor 420. The floating point execution unit 321 includes an execution optimizer 430 that is coupled to adaptive execution logic 425 via bus 435. The adaptive execution logic 425 provides a floating point result to an adaptive result register 426 via bus 436. The adaptive floating point execution unit 421 receives a precision-adaptive input operand via an OP bus 431 and its corresponding precision (as provided from the memory 410) via a PTAG bus 432. The adaptive floating point execution unit 421 provides a precision-adaptive result operand to the tagged register file 422 via an ROP bus 433 and its corresponding precision (as specified via contents of a floating point control word 427) via an RPTG bus 433. The adaptive floating point execution unit 421 is coupled to the floating point control word 427. The floating point control word 427 has a rounding control field 428 and a precision control field 429. The value of the precision control field 429 indicates a result precision (e.g., single, double, double extended) to which the result operand is to be rounded. The contents of the rounding control field indicates how the result operand is to be rounded to the specified result precision. Exemplary rounding schemes include round to nearest, round down, round up, and round toward zero (i.e., truncate). Such rounding schemes are provided for by an x87-compatible floating point unit.

To further illustrate aspects of the present invention, note that significands 411413 corresponding to three floating point numbers A-C are shown stored within the memory 410 Number A is stored as a single precision number having a 24-bit significand 411. Number B is stored as a double precision number having a 52-bit significand 412. And number C is encoded as a double extended precision number having a 64-bit significand 413. Yet, in contrast to a conventional microprocessor 320 as described with reference to FIG. 3, the microprocessor 420 according to the present invention records the corresponding precision of each input operand that is fetched from memory 410 and provided to the tagged register file 422. When number A is fetched from the memory 410, its 24-bit significand 411 is expanded to a 64-bit significand by the adaptive conversion logic 423 for storage in a register within the register file 422 as a double extended precision number. Accordingly, the lower 40 bits of the significand of number A are set to zero. But, in addition to converting input operands to full-precision format (i.e., in one embodiment, double extended precision format), the adaptive conversion logic 423 also records the original precision of each of the input operands, and provides this original precision to an associated entry in the tagged register file 422. In substantially similar manner, when number B is fetched from the memory 310, its 52-bit significand 412 is expanded to a 64-bit significand by the adaptive conversion logic 423 for storage in the tagged register file 422 as a double extended precision number, but also preserves the corresponding precision of number B as fetched from memory 410. And although the lower 11 bits of the significand of number B within the register file 422 are set to zero, the fact that this number of least significant bits in the significand are zero is indicated therein. Since number C is stored in memory 410 in double extended precision format, the 64-bit significand 413 is merely transferred to a designated register in the tagged register file 422 along with an indication of the original precision of number C.

It is noted that, in contrast to a conventional microprocessor 320, after numbers A-C have been fetched from the memory 410, converted by the adaptive conversion logic 423 to double extended precision format, and loaded into the tagged register file 422, their respective precisions have been preserved and they are may thereafter be operated in such a manner as is appropriate to decrease, or minimize, the number of sub-operations or steps that are required to perform a prescribed floating point operation. For example, to perform a floating point operation on the contents of a register containing number A (formerly having only 24 bits of significand) would require significantly fewer steps and/or sub-operations as it does to perform the same floating point operation on the contents of a register containing number C. Because the precision of number A is preserved by the adaptive conversion logic, it is provided over the PTAG bus 432 to the execution optimizer when number A is provided over the OP bus 431. The execution optimizer 430 can thereby determine how the operation precision that is required to perform the prescribed floating point operation on operand A and specifies this operation precision to the adaptive execution logic 425 via bus 435. In one embodiment, the operation precision is either single precision, double precision, or double extended precision. In turn, the adaptive execution logic 425 is configured to perform the prescribed floating point operation according to the operation precision specified via bus 435. In one embodiment, when the preserved precision of all of the input operands for a given floating point operation is single precision, then the operation precision is specified via bus 435 as single precision. When the preserved precision of all of the input operands for a given floating point operation is double precision or single precision, then the operation precision is specified via bus 435 as double precision. When the preserved precision of one of the input operands for a given floating point operation is double extended precision, then the operation precision is specified via bus 435 as double extended precision.

In contrast to the example of FIG. 3, when an application program sets single precision as a default operand size, then instructions are executed to set the value of the precision field 429 in the floating point control word 427 to specify single precision format. And considering that input operands are provided from memory 310 in single precision format, and their corresponding precisions are preserved when they are converted to double extended precision format and stored in the tagged register file 422, the floating point operations that are subsequently performed on the input operands are performed as single precision operations. This is because the adaptive floating point unit 421 is provided not only with double extended precision operands via the OP bus 431, but their corresponding precision (i.e., single precision) is provided via the PTAG bus 432. Thus, the execution optimizer 430 prescribes single precision as an operation precision for this floating point operation and the number of sub-operations and/or steps required to perform these floating point operations are markedly decrease, thus resulting in a faster execution time for the application program.

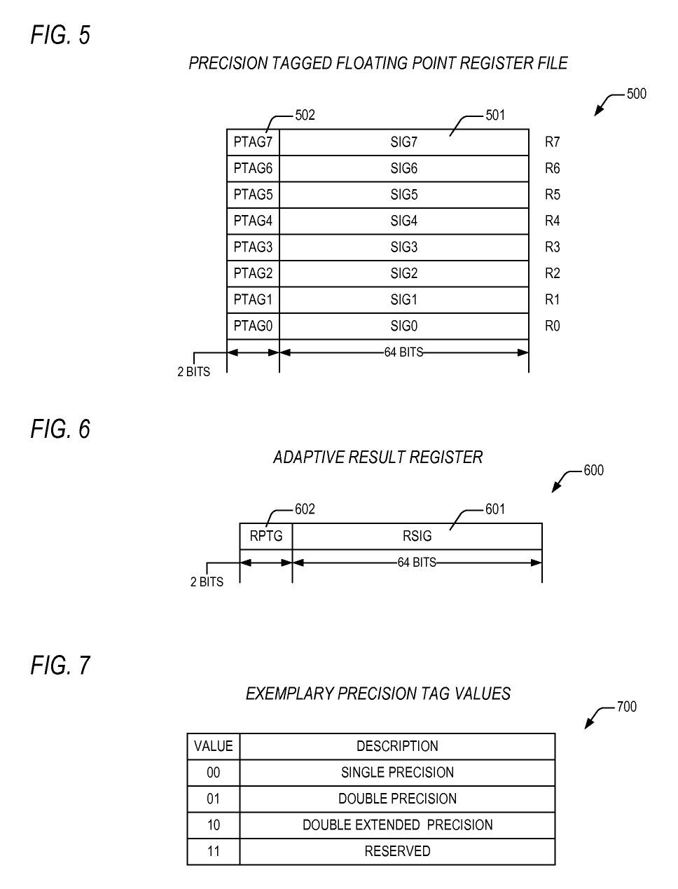

Now turning to FIG. 5, a block diagram is presented illustrating a precision tagged floating point register file 500 according to the present invention. The tagged floating point register file 500 has a plurality of entries, or registers. In one embodiment, the register file 500 includes eight registers R0-R7. Each of the registers R0-R7 has a significand field 501 and a precision tag field 502. In one embodiment, the significand field 501 is 64 bits to allow for storage of the significand for double extended precision operands according to the IEEE 754 Standard format. Each of the registers R0-R7 also includes a sign field (not shown) and an exponent field (not shown) which are not depicted for clarity purposes. Contents of the precision tag field 502 is provided by adaptive conversion logic according to the present invention and indicates a precision of a corresponding operand as provided from memory, prior to conversion of the operand to a precision commensurate with the size of the significand field 501. In one embodiment, the precision indicated by the value of the precision field 502 denotes the number of zeros that have been appended to the least significant bits of a lower precision significand when the lower precision significand was converted for storage in the register file 500.

FIG. 6 is a block diagram detailing an adaptive floating point result register 600 according to the present invention. A floating point result operand according to the present invention is provided thereto from adaptive execution logic via a bus, such as bus 436 of FIG. 4. The result register 600 is has a result significand field 601 and a result precision tag field 602. In one embodiment, the result significand field 601 is 64 bits to allow for storage of the result significand for double extended precision operands according to the IEEE 754 Standard format, when provided back into a precision tagged floating point register file. The result register 600 also includes a sign field (not shown) and an exponent field (not shown) which are not depicted for clarity purposes. In one embodiment, the precision indicated by the value of the result precision field 602 denotes the number of zeros that have been appended to the least significant bits of a lower precision result significand when the lower precision significand was rounded to a precision specified by a precision field of a floating point control word.

FIG. 7 is a table 700 showing exemplary encodings of the precision tags of the tagged floating point register file of FIG. 5 and the adaptive result register of FIG. 6. In one embodiment, the precision tag fields 502, 602 and 2-bit fields 502, 602. Accordingly, a value of 00 indicates that a corresponding operand is a single precision operand. A value of 01 indicates that the corresponding operand is a double precision operand. A value of 10 indicates that the corresponding operand is a double extended precision operand. Value 11 is reserved.

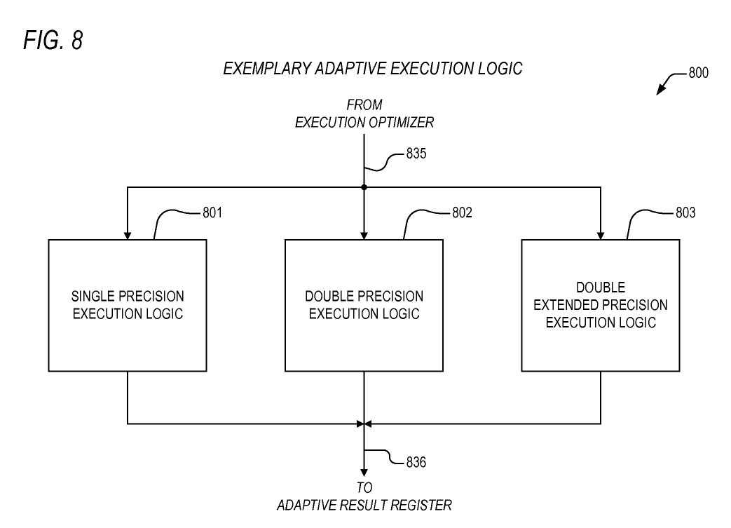

FIG. 8 is a block diagram featuring a exemplary embodiment of adaptive floating point execution logic 800 according to the present invention. The adaptive execution logic 800 includes single precision execution logic 801, double precision execution logic 802, and double extended precision execution logic 803. Bus 835 provides operands and an operation precision for performance of a prescribed floating point operation as directed by an execution optimizer according to the present invention. If the operation precision is single precision, then the operands are provided to the single precision execution logic 801 for generation of a result via performing the prescribed floating point operation as a single precision operation. The result is provided to an adaptive result register via bus 836. Likewise, if the operation precision is double precision, then the operands are provided to the double precision execution logic 802 for generation of a result via performing the prescribed floating point operation as a double precision operation. And, if the operation precision is double extended precision, then the operands are provided to the double extended precision execution logic 803 for generation of a result via performing the prescribed floating point operation as a double extended precision operation. It is noted that the single precision logic 801, double precision logic 802, and the double extended precision logic 803 may comprise logic, circuits, devices, or microcode (i.e., micro instructions or native instructions), or a combination of logic, circuits, devices, or microcode, or equivalent elements that are employed to perform the aforementioned functions and that the elements employed to perform these aforementioned functions may be shared with other circuits, microcode, etc., that are employed to perform other functions or portions of the aforementioned functions within an adaptive floating point execution unit according to the present invention.

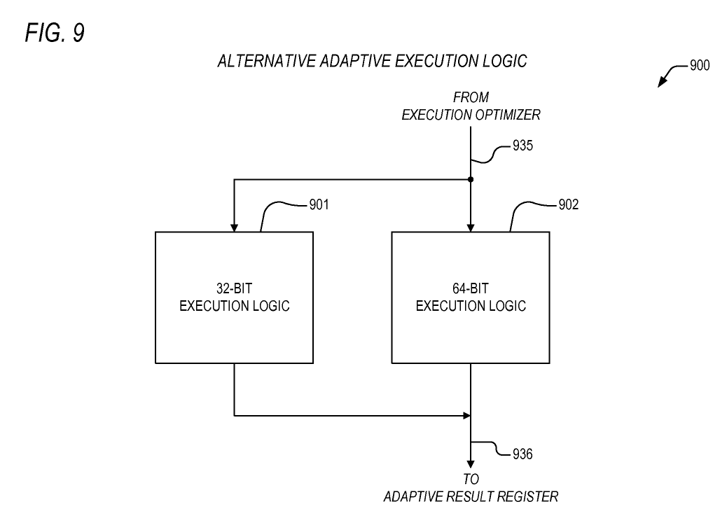

Turning to FIG. 9, a block diagram is presented showing an alternative embodiment of adaptive floating point execution logic 900 according to the present invention. In this alternative embodiment, the adaptive execution logic 900 includes 32-bit execution logic 901 and 64-bit execution logic 902. Bus 935 provides operands and an operation precision for performance of a prescribed floating point operation as directed by an execution optimizer according to the present invention. If the operation precision indicates significand precision less than or equal to 32 bits, then the operands are provided to the 32-bit execution logic 901 for generation of a result via performing the prescribed floating point operation as a 32-bit operation. The result is provided to an adaptive result register via bus 936. Likewise, if the operation precision indicates significand precision greater than 32 bits, then the operands are provided to the 64-bit execution logic 902 for generation of a result via performing the prescribed floating point operation as a 64-bit operation. It is noted that the 32-bit execution logic 901 and the 64-bit execution logic 902 may comprise logic, circuits, devices, or microcode (i.e., micro instructions or native instructions), or a combination of logic, circuits, devices, or microcode, or equivalent elements that are employed to perform the noted functions and that the elements employed to perform these noted functions may be shared with other circuits, microcode, etc., that are employed to perform other functions or portions of the aforementioned functions within an adaptive floating point execution unit according to the present invention.

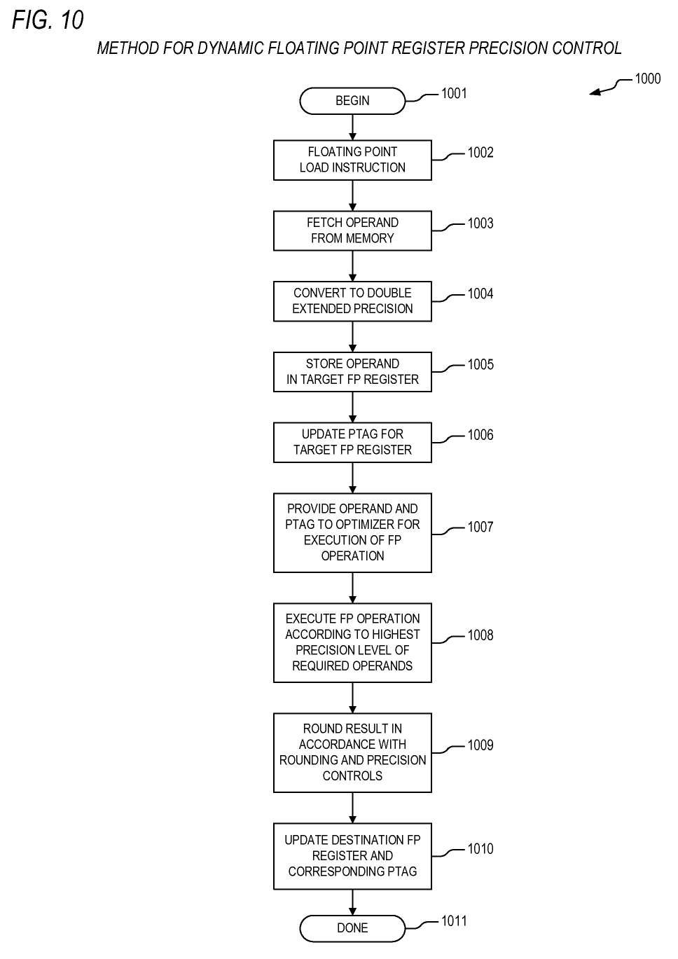

Now referring to FIG. 10, a flowchart 1000 is presented illustrating a method according to the present invention for performing precision-adaptive floating point operations. Flow begins at block 1001 where a microprocessor according to the present invention begins execution of a flow of floating point instructions. Flow then proceeds to block 1002.

At block 1002, a floating point load instruction is executed to load a prescribed floating point operand from a location in memory. Flow then proceeds to block 1003.

At block 1003, the operand, having a precision as provided in memory, is fetched and the precision as provided in memory is recorded. Flow then proceeds to block 1004.

At block 1004, the fetched operand is converted to a double extended precision operand by appending (if required) additional bits set to zero to its least significant bit position of its associated significand and modifying its exponent to comport with the additional number of exponent bits. Flow then proceeds to block 1005.

At block 1005, the double extended precision operand is stored in a target tagged floating point register according to the present invention. Flow then proceeds to block 1006.

At block 1006, a precision tag field within the target tagged floating point register is updated to indicate the precision which was recorded in block 1003. Flow then proceeds to block 1007.

At block 1007, both the double precision operand and its corresponding precision tag are provided to an execution optimizer according to the present invention for performance of a prescribed floating point operation. Flow then proceeds to block 1008.

At block 1008, the prescribed floating point operation is performed at an operation precision level according to the highest precision level of its required operands and a result is generated. Flow then proceeds to block 1009.

At block 1009, the result is rounded to a precision level prescribed by a floating point control word according to a specified rounding scheme. Flow then proceeds to block 1010.

At block 1010, the rounded result is provided to a destination floating point register in the tagged register file and its corresponding precision tag is updated to indicate the result precision of block 1009. Flow then proceeds to block 1011.

At block 1011, the method completes.

Although the present invention and its objects, features, and advantages have been described in detail, other embodiments are encompassed by the invention as well. For example, the well known x86/x87 architecture has been employed herein to describe certain aspects of the present invention. But it is noted that the scope of the present invention extends beyond the boundaries of x86/x87 architecture to comprehend other architectures as well which up convert floating point operands to a higher-level precision that that which they are supplied, without preserving their original precision for purposes of optimizing subsequent floating point operations thereon to reduce execution time.

In addition, the present invention has been described in terms of the ubiquitous IEEE 754 Standard for representation of floating point numbers. As such, the terms single precision, double precision, and double extended precision have been utilized herein to allow for a description of essential concepts and elements. However, the present inventors note that other “precision” standards are encompassed as well when it is considered that the present invention allows for preservation of any precision in which an input operand is supplied from a source therefrom, and employs this preserved precision when determining at what level of precision to perform a subsequent floating point operation.

Moreover, although the present invention has been taught in terms of an adaptive floating point unit within microprocessor, such concepts apply equally to a wide variety of processing devices to include microcontrollers, industrial controllers, signal processors, array processors, and like devices that perform floating point operations upon floating point operands.

Those skilled in the art should appreciate that they can readily use the disclosed conception and specific embodiments as a basis for designing or modifying other structures for carrying out the same purposes of the present invention, and that various changes, substitutions and alterations can be made herein without departing from the scope of the invention as defined by the appended claims.

What is claimed is:

1. A microprocessor apparatus, for performing floating point operations that are adaptive to the precision formats of input operands, the microprocessor apparatus comprising:
adaptive conversion logic, configured to receive the input operands, wherein each of the input operands is of a corresponding precision, and configured to record said corresponding precision for use in subsequent floating point operations; and
a tagged register file; coupled to said adaptive conversion logic, configured to store said each of the input operands, and configured to store said corresponding precision and to associate said corresponding precision with said each of the input operands;
wherein said subsequent floating point operations are performed at a precision level according to said corresponding precision.

2. The microprocessor apparatus as recited in claim 1, wherein said tagged register file comprises a plurality of registers, each of said plurality of registers comprising a significand field and a precision tag field.

3. The microprocessor apparatus as recited in claim 2, wherein said precision tag field indicates said corresponding precision.

4. The microprocessor apparatus as recited in claim 2, wherein said significand field comprises 64 bits.

5. The microprocessor apparatus as recited in claim 1, wherein the precision formats and said corresponding precision comport with IEEE Standard 754-1985, IEEE Standard for Binary Floating-Point Arithmetic.

6. The microprocessor apparatus as recited in claim 5, wherein said adaptive conversion logic converts a first operand received in a single precision format to a double extended precision format for storage in said tagged register file, and wherein said adaptive conversion logic records said single precision format as said corresponding precision.

7. The microprocessor apparatus as recited in claim 5, wherein said adaptive conversion logic converts a first operand received in a double precision format to a double extended precision format for storage in said tagged register file, and wherein said adaptive conversion logic preserves said double precision format as said corresponding precision.

8. The microprocessor apparatus as recited in claim 5, wherein said adaptive conversion logic maintains a first operand received in a double extended precision format in said double extended precision format for storage in said tagged register file, and wherein said adaptive conversion logic preserves said double extended precision format as said corresponding precision.

9. The microprocessor apparatus as recited in claim 1, wherein the input operands are fetched from a memory and are provided to said adaptive conversion logic.

10. The microprocessor apparatus as recited in claim 1, wherein result operands are provided to said tagged register file, and wherein each of said result operands are provided with a corresponding result precision, and wherein said corresponding result precision is established according to a floating point control word.

11. The microprocessor apparatus as recited in claim 1, wherein said subsequent floating point operations are X86-compatible floating point operations.

12. An apparatus in a microprocessor, for performing floating point operations that are adaptive to the precisions of input operands, the apparatus comprising:
adaptive conversion logic, configured to receive the input operands, wherein each of the input operands is of a corresponding precision, and configured to record said corresponding precision for use in subsequent floating point operations; and
a plurality of tagged registers; coupled to said adaptive conversion logic, each configured to store said each of the input operands, said each comprising:
a precision tag field, configured to store a value indicating said corresponding precision; and
a significand field, coupled to said precision tag field, configured to store a significand corresponding to said each of the input operands.
wherein said subsequent floating point operations are performed at a precision level according to said corresponding precision.

13. The apparatus as recited in claim 12, wherein said significand field comprises 64 bits, and wherein said adaptive conversion logic converts the input operands into a double extended precision format for storage in said plurality of tagged registers.

14. The apparatus as recited in claim 13, wherein said precision tag field indicates how many least significant bits in said significand field are set to zero.

15. The apparatus as recited in claim 12, wherein an adaptive floating point execution unit employs said precision tag field to determine a highest precision level for performance of said subsequent floating point operations.

16. The apparatus as recited in claim 15, wherein said adaptive floating point execution unit generates result operands that are provided to said plurality of tagged registers, and wherein each of said result operands are provided with a corresponding result precision, and wherein said corresponding result precision is established in accordance with a precision field within a floating point control word.

17. A method for performing floating point operations in a microprocessor that are adaptive to the precision formats of input operands, the method comprising:
receiving the input operands, wherein each of the input operands is of a corresponding precision;
recording the corresponding precision when the each of the input operands is converted to a storage precision, and storing the corresponding precision in a tagged register; and
providing the corresponding precision for use in a subsequent floating point operation.

18. The method as recited in claim 17, wherein said storing comprises:
indicating the corresponding precision via a precision tag field within the tagged register.

19. The method as recited in claim 17, wherein said preserving comprises:
employing a significand field within the tagged register, the significand field having a number of bits that are equal to or greater than that required to store the corresponding precision.

20. The method as recited in claim 17, further comprising:
fetching the input operands from a memory.

21. The method as recited in claim 17, further comprising:
employing the corresponding precision in the subsequent floating point operation to minimize the number of sub-operations that are required to generate a result.

22. The method as recited in claim 21, further comprising: generating the result, wherein the result is of a result precision; and indicating the result precision when the result is provided to a destination tagged register.
